(19) United States
(12) Patent Application Publication
(10) Pub. No.: US 2024/0242459 A1
(43) Pub. Date: Jul. 18, 2024

(54) METHOD FOR DETECTING ALARM OBJECTS IN ITEMS OF LUGGAGE IN A DETECTION APPARATUS

(71) Applicant: SMITHS DETECTION GERMANY GMBH, Wiesbaden (DE)

(72) Inventors: Klaus-Dieter MÜLLER, Wiesbaden (DE); Geert HEILMANN, Wiesbaden (DE); Dennis CZEREMIN, Ensheim (DE); Christian GOTTWALD, Mainz (DE)

(21) Appl. No.: 18/282,107

(22) PCT Filed: Mar. 14, 2022
(86) PCT No.: PCT/EP2022/056444

§ 371 Date: Mar. 26, 2024

(30) Foreign Application Priority Data
Mar. 15, 2021 (DE) 102021202510.2

(51) Int. Cl. G06V 10/10; G06T 7/70; G06V 10/22; G06V 10/82

(52) U.S. Cl. CPC G06V 10/16; G06T 7/70; G06V 10/225; G06V 10/82; G06V 2201/05

(57) ABSTRACT

The disclosure relates to a method for detecting alarm objects in items of luggage in a detection device. The method includes scanning a first two-dimensional inspection strip of a first part of the item of luggage, evaluating the first two-dimensional inspection strip for the presence of partial sections of alarm objects, outputting an inspection result based on the evaluation of the first inspection strip, scanning at least a second two-dimensional inspection strip of a second part of the item of luggage, evaluating the second two-dimensional inspection strip for the presence of partial sections of alarm objects, and outputting an inspection result based on the evaluation of the second inspection strip.

### CROSS-REFERENCE TO RELATED APPLICATIONS

The present application is a national stage entry of PCT/EP2022/056444 filed on Mar. 14, 2022, which claims the benefits of DE Patent Application No. 102021202510.2 filed on Mar. 15, 2021, the contents of which are hereby incorporated by reference in their entirety.

### BACKGROUND

The present disclosure relates to a method for detecting alarm objects in items of luggage in a detection device, an evaluation device for carrying out such a method and a corresponding computer program product.

It is known for automated detection methods to be used in detection devices at security gates, for example in airports. Often, neural networks are also used as so-called artificial intelligence for evaluation in such automated detection methods. Usually, such detection devices are equipped with a scanning unit which enables the item of luggage to be screened by means of electromagnetic radiation. In this way, inspection images are generated which can then be used as a basis for the evaluation.

A disadvantage of the known solutions is that it is necessary to wait until the complete item of luggage has been scanned by the detection device. In other words, in the known solutions an item of luggage is completely screened in a first step and in this way an inspection image specific to this item of luggage is generated. This inspection image is then examined using a neural network so that an evaluation can be carried out, in an automated manner, with regard to the presence of alarm objects within this item of luggage. A disadvantage of this solution is that it is always necessary to wait until the complete inspection image is available in order to start the evaluation. In a case where several items of luggage within the detection device lie directly adjacent to each other or even on top of each other, it takes a very long time until such an inspection image is complete. It may even happen that the monitor of the operating personnel at such a security gate is not large enough to fully display such a very elongated inspection image. This can lead to a situation where a particularly long inspection image is only evaluated when the first part of this inspection image no longer actually appears on the monitor of the inspection personnel. This can lead to a security risk, which is usually countered in that each item of luggage has to be arranged in individual trays. However, this leads to a significant reduction in throughput during the inspection of items of luggage, so that it takes the same amount of time to check a smaller number of items of luggage.

### BRIEF DESCRIPTION

The present disclosure remedies, at least in part, the disadvantages described above. In particular, the present disclosure improves and/or accelerates the detection of alarm objects in an item of luggage in a cost-effective and simple manner.

This is achieved by a method with the features of claim 1, an evaluation device with the features of claim 12 and a computer program product with the features of claim 14. Further features and details of the disclosure are disclosed in the dependent claims, the description and the drawings. Naturally, features and details described in connection with the method according to the disclosure also apply in connection with the evaluation device according to the disclosure and the computer program product according to the disclosure and vice versa, so that, with regard to disclosure, mutual reference is or can always be made to the individual aspects of the disclosure.

According to the disclosure, a method for detecting alarm objects in items of luggage in a detection device is provided. For this purpose, the method includes the following steps:
scanning a first two-dimensional inspection strip of a first part of the item of luggage,
evaluating the first two-dimensional inspection strip for the presence of partial sections of alarm objects,
outputting an inspection result based on the evaluation of the first inspection strip,
scanning at least a second two-dimensional inspection strip of a second part of the item of luggage,
evaluating the second two-dimensional inspection strip for the presence of partial sections of alarm objects,
outputting an inspection result based on the evaluation of the second inspection strip.

A method according to the disclosure is therefore based on the basic detection functionality of known detection devices. If, for example, it is used for a detection device with an electromagnetic scanning unit as a detection module, these electromagnetic scanning units are usually designed in such a way that they scan the item of luggage strip by strip. This can be an electromagnetic radiation unit installed in a fixed position and an associated detection unit. Naturally, moveable, especially rotatable, detection modules can also be used for a method according to the disclosure.

However, in contrast to the known solutions, in a method according to the disclosure it is not necessary to wait until a complete inspection image has been built up from the individual inspection strips. Rather, according to the disclosure, as soon as a first two-dimensional inspection strip has been scanned, this two-dimensional inspection strip is evaluated directly. The evaluation can be carried out manually, algorithmically and/or by applying artificial intelligence with the help of a neural network. This evaluation of the first two-dimensional inspection strip is also directly followed by the output of an associated inspection result. Of course, the strip-by-strip scanning of the two-dimensional inspection strip can proceed continuously in the known way. Subsequently, and also in sequential succession, the evaluation of the two-dimensional inspection strip and the output of the inspection result may already takes place in parallel with the scanning.

It can be seen from the above explanation that, compared to the known solutions, not only is an image of the already-scanned two-dimensional inspection strips built up, an inspection result which is also being built up at the same time is also output in this image which is being built up.

For example, an inspection of items of luggage can take place at a security gate of an airport. Certain objects, such as weapons, explosives or the like, are prohibited in such items of luggage. Such prohibited objects are referred to as alarm objects in the context of the present disclosure. If an inspection of the luggage is desired at the security gate, the items of luggage are placed on a conveyor belt in the usual way and transported into the detection device. During transport through the detection device, the item of luggage is screened strip by strip, whereby the first inspection strip is automatically evaluated as soon as it has been scanned, and then the result of this first evaluation process is output. According to the disclosure, not only are the scanned inspection strips built up strip by strip for the operating personnel of such a security gate on an associated screening monitor, but also, already integrated therein, the inspection result, which is also output strip by strip. If, for example, a marking or other visual representation of alarm objects is provided as an inspection result, this can also be done on a strip-by-strip basis.

Based on the strip-by-strip detection, which is in turn based on the strip-by-strip scanning of the individual inspection strips, a method according to the disclosure can identify an alarm object much faster than is the case with the known solutions. In particular, partial sections of alarm objects are already recognised as such or recognised as belonging to such alarm objects. This makes it possible already to display such an alarm object, even in the case of long items of luggage whose inspection images would not fit completely on an associated control monitor, if it has been detected in partial sections in an inspection strip by the evaluation.

As can be seen from the previous explanation, it is no longer necessary to wait until a complete item of luggage has been fully scanned. Rather, not only the scanning, but also the evaluation for the presence of alarm objects is already carried out as the item of luggage passes through. In addition to accelerating the basic throughput speed of items of luggage, this means that the use of separation trays can be dispensed with and thus the total throughput of scanned items of luggage can be increased even further.

In addition, the reliability of the use of such a detection device is increased, since the inspection result is already built up in the optical image during the construction of the image, i.e. an alarm object can also be detected as such significantly sooner.

It should also be noted that inspection results of individual inspection strips can be combined with each other directly after the evaluation. For example, an alarm object which extends over three inspection strips can already be marked as such after the end of the evaluation of this third inspection strip and an alarm issued, even if the associated item of luggage is 50 or more inspection strips long. A step of combining individual inspection results into a common alarm while further inspection is still ongoing is therefore possible, as will be explained in more detail with reference to the independent claims.

It may be advantageous if, in a method according to the disclosure, in addition to the presence of partial sections of alarm objects, their relative position in relation to lateral margins of the inspection strip is recorded during the evaluation. As has already been explained, it is sufficient for the evaluation that at least partial sections of alarm objects are contained in the respective inspection strip. For example, alarm objects can be of different sizes, so that where the inspection strips have very narrow inspection widths, the alarm objects are only partially contained in the respective inspection strip. By evaluating the relative position of this detected partial section in relation to the inspection strip, it becomes clear whether the alarm object is completely contained within this scanned inspection strip or extends into a neighbouring and/or adjacent inspection strip. This makes it possible to distinguish whether an alarm object has already been detected completely within an inspection strip or extends beyond this margin into a neighbouring inspection strip. In particular, this overlap can be used to generate and/or supplement the marking accordingly during the individual evaluation steps.

It is also advantageous if, in a method according to the disclosure, where a recorded relative position of the partial section is in direct contact with a lateral margin, a combination with the inspection strip adjacent to this lateral margin takes place when the inspection result is output. For example, it is possible to provide a combined output of two inspection strips and thus of two inspection results for the output of the inspection result. It is also possible to combine an optical marking of the detected partial section of the alarm object in this way.

It is also advantageous if, in a method according to the disclosure, an optical marking of the present partial section of the alarm object and/or the present alarm object is carried out for the output of the inspection result. This may for example be a coloured marking. For example, it is also possible to include borders on a visual representation of the inspection result in order to visually highlight, through colour or otherwise, a detected alarm object or the detected partial section of the alarm object. In particular, this consists of a geometric shape, for example a rectangular frame, on the output inspection result.

It is also advantageous if, in a method according to the disclosure, in the case of an alarm object which extends over at least two inspection sections, the optical marking is generated as the smallest possible boundary, in particular with a specified geometric shape. Since it is basically possible to colour the detected alarm object separately, for example, it is also conceivable and above all involves less computational effort to implement an optical marking as a frame around the detected alarm object. For example, it is conceivable that a given geometric shape in the form of a rectangle, a square, an ellipse, a circle or the like is used to visually highlight the alarm object as the smallest possible boundary. In such a case, the inspection result is again provided as a visual output, for example on the operating personnel's monitor.

It is also advantageous if, in a method according to the disclosure, the inspection strips overlap with each other, especially along a scanning direction. In other words, duplicate detection steps are carried out in this way, whereby the overlapping areas are taken into account when the inspection result is output. In particular, this takes place when a continuous or substantially continuous scanning of the individual inspection strips is carried out, for example by continuously moving the item of luggage along the scanning direction. This also applies in the same way to a moveable scanning device, for example a rotating scanning module.

It can bring further advantages if, in a method according to the disclosure, the scanning inspection strips have identical or substantially identical inspection widths. In particular, the length of the inspection strips transversely to the inspection width is also identical or substantially identical. Due to the identical or substantially identical geometric design of the inspection strips, the subsequent processing in the evaluation and also the output of the inspection result is simplified, since substantially the same basic geometry can always be taken into account or processed.

It can also have advantages if, in a method according to the disclosure, an inspection width is variable for at least one inspection strip which is to be scanned. Such a possibility of variation can be provided in a manual form, but also in an automated form. In this way, an inspection width can be adapted to a specific situation. For example, when detecting a partial section of an alarm object which extends beyond the lateral margin of the inspection strip, it is conceivable to increase the inspection width of this inspection strip to such an extent that the alarm object is completely or substantially completely located within this inspection strip during the next pass. If a particularly complex detection task is involved, it can also make sense to significantly reduce the inspection width, so that the computational effort in the evaluation of each inspection strip decreases due to the reduction of the inspection width. This makes it possible to adapt a method according to the disclosure to the actual conditions in a corresponding situation by varying the inspection width.

It is also advantageous if, in a method according to the disclosure, the output of the inspection result takes place continuously after each evaluation of an individual inspection strip. In addition to the continuous evaluation, the output is in this way also continuous, so that not only is the inspection image built up strip by strip on the monitor at a security gate, the evaluation is also already integrated into this strip-by-strip construction of the inspection image. Depending on the speed at which it is generated, the inspection result can be output together with the scanned inspection strip, but also subsequently. The result, so to speak, is an optical throughput that corresponds or substantially corresponds to the real throughput of the item of luggage along the scanning direction.

It can also have advantages if, in a method according to the disclosure, the evaluation of the inspection strips is carried out by means of a neural network, in particular for all inspection strips with an identical neural network. This may be the same network, so that a neural chip with such a neural network can evaluate each inspection strip sequentially, one after the other. This leads to a significant reduction in costs, as the complete continuous evaluation can be made available with a single neural chip. For the purposes of the present disclosure, a neural chip is to be understood as a processing unit on which the neural network is stored and/or executed. A set of training data may be built up strip by strip is also used for the training of such a neural network. Of course, it is also possible that such a neural network is designed to be self-learning, i.e., when alarm objects are detected which are verified as such, to return this information to the neural network for a self-learning functionality.

It is also advantageous if, in a method according to the disclosure, the inspection strips are directly or substantially directly adjacent to each other. This means that there is neither an overlap nor a gap between inspection strips. In this way, seamless monitoring can be ensured, especially when luggage passes through along the scanning direction of the scanning device. As soon as no more items of luggage are present, it may make sense to generate the inspection strips at a distance from each other in order to reduce the effort of monitoring when no luggage is present.

The subject matter of the present disclosure also includes an evaluation device for detecting alarm objects in items of luggage in a detection device. Such an evaluation device includes a scanning module for scanning a first two-dimensional inspection strip of a first part of the item of luggage and for scanning at least a second two-dimensional inspection strip of a second part of the item of luggage. The evaluation device is also equipped with an evaluation module for evaluating the first two-dimensional inspection strip for the presence of partial sections of alarm objects and for evaluating the second two-dimensional inspection strip for the presence of partial sections of alarm objects. In addition, an output module is provided for outputting an inspection result based on the inspection strips. The evaluation module, the scanning module and/or the output module may be designed to carry out a method according to the disclosure. Thus, an evaluation device according to the disclosure brings the same advantages as have been explained in detail with reference to a method according to the disclosure.

The subject matter of the present disclosure also includes a computer program product including instructions which, when the program is run by a computer, cause the computer to carry out the steps of a method according to the disclosure. Thus, a computer program product according to the disclosure also brings the same advantages as have been explained in detail with reference to a method according to the disclosure.

### BRIEF DESCRIPTION OF THE DRAWINGS

Further advantages, features and details of the disclosure are explained in the following description, in which embodiments of the disclosure are described in detail with reference to the drawings. The features mentioned in the claims and in the description may in each case be essential to the disclosure individually or in any combination. In each case schematically:

FIG. 1 shows an embodiment of a detection device according to the disclosure,

FIG. 2 shows a possible run of a strip-by-strip detection,

FIG. 3 shows an embodiment of a method according to the disclosure,

FIG. 4 shows an embodiment of a method according to the disclosure,

FIG. 5 shows an embodiment of a method according to the disclosure,

FIG. 6 shows an embodiment of a method according to the disclosure,

FIG. 7 shows an embodiment of a method according to the disclosure,

FIG. 8 shows an embodiment of a method according to the disclosure and

FIG. 9 shows an embodiment of an evaluation device according to the disclosure.

### DETAILED DESCRIPTION

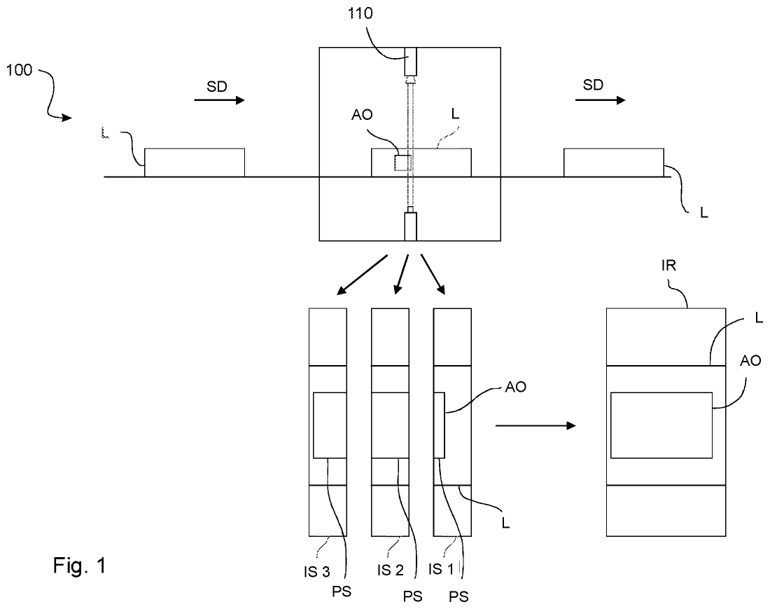

FIG. 1 shows schematically a security gate which is equipped with a detection device 100. On a baggage carousel, items of luggage L run on a conveyor belt through a detection chamber in which a detection module emits 110 electromagnetic rays. With a corresponding detection section of the detection module 110, a screening result can be generated strip by strip. Schematically, FIG. 1 clearly shows that a large number of two-dimensional inspection strips IS1, IS2 and IS3 are now generated with the help of the detection module 110. In this embodiment, each of these inspection strips IS1, IS2, IS3 directly abuts the preceding inspection strip IS1, IS2 and IS3. In each of the inspection strips IS1, IS2 and IS3, a partial section PS of an alarm object AO can be seen which is arranged in the item of luggage L. An inspection result IR is generated from these scanned inspection strips IS1, IS2, IS3 in which the alarm object AO is represented, marked and/or displayed visually as such in the item of luggage L.

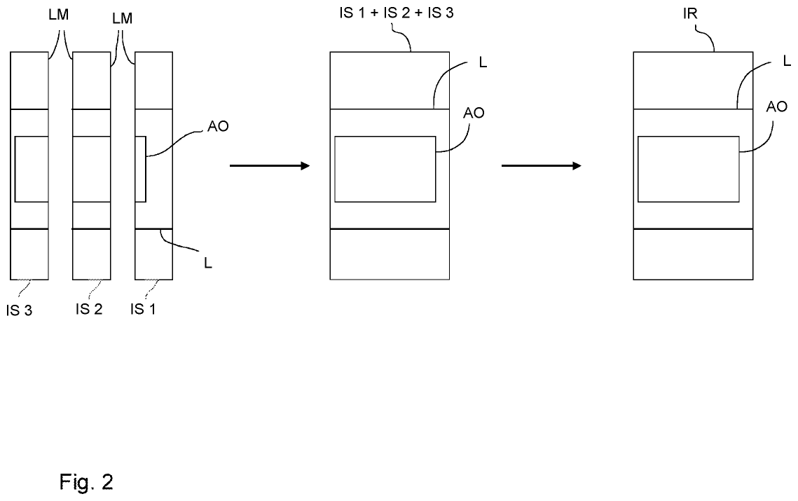

FIG. 2 shows a similar possibility to FIG. 1, but in this case the relative position in which the partial section PS of the alarm object AO is located in the respective inspection strip IS1, IS2 and IS3 is checked. For example, in FIG. 2 on the left, it is detected that the alarm object AO extends beyond the first inspection strip IS1 to the left, beyond its lateral margin LM. As soon as this is detected, this first inspection strip IS1 can be combined with the second inspection strip IS2. Now it is recognised that the alarm object AO is even larger and also extends beyond its lateral margin LM. Thus, the inspection strips IS1, IS2 and IS3 are combined with each other to form a common inspection strip as shown in FIG. 2 and accordingly also output as a common inspection result IR.

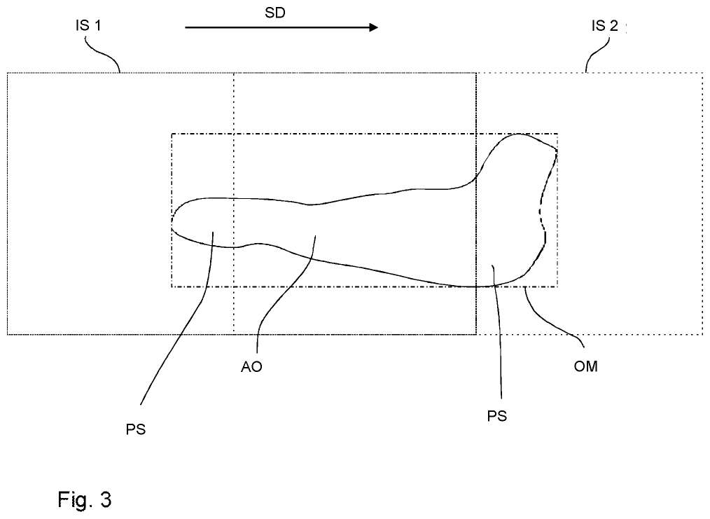

FIG. 3 shows a variant in which the inspection strips IS1 and IS2 overlap with each other along the scanning direction SD. Here, a freely formed alarm object AO, which is now located partly within an overlapping section, is shown schematically. Here too, it is conceivable in principle to combine the two inspection strip IS1 and IS2 for further evaluation. In particular, however, a combination of these overlapping inspection strips IS1 and IS2 is carried out for the output of the inspection result IR. Thus, it is also possible that, with the help of an optical marking OM, in this case a predefined rectangle, an optical and visual highlighting of the alarm object AO takes place on a monitor at a security gate. In this embodiment in FIG. 3, the optical marking OM is a rectangle which has a minimum extension in order to delimit the alarm object AO.

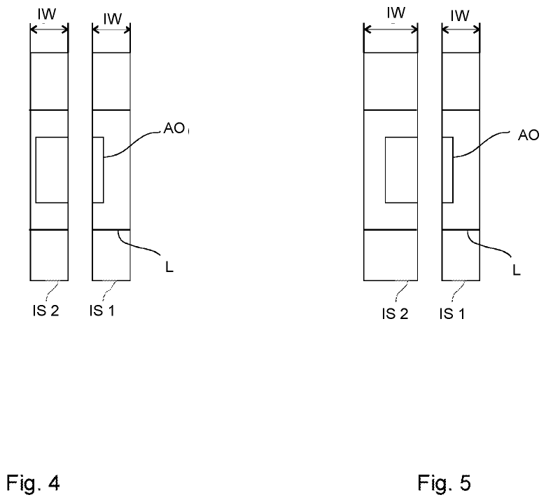

In FIGS. 4 and 5, reference is made to the geometric shape of the inspection strips IS1 and IS2. In FIG. 4, all inspection strips IS1 and IS2 are provided with an identical inspection width IW. According to FIG. 5, the second inspection strip IS2 is provided with an enlarged inspection width IW, in this case in particular to integrate the complete alarm object AO into these two inspection strips IS1 and IS2. The variation of the inspection width IW can either be automated, specified or manually varied.

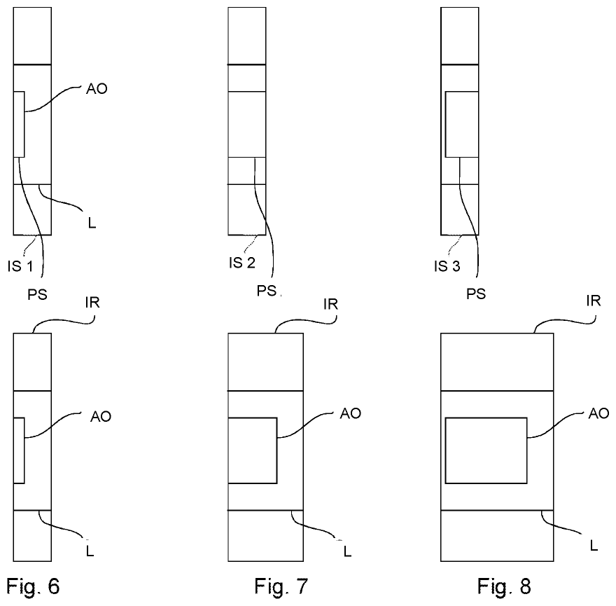

FIGS. 6, 7 and 8 show schematically how an inspection result IR can build up continuously. To begin with, a first inspection strip IS1 is scanned and, accordingly, a strip-by-strip inspection result IR is output as shown in FIG. 6. Then, with the help of the detection module 110, another inspection strip IS2 is scanned which then continuously expands or supplements the inspection result IR shown in FIG. 7 from FIG. 6. In the same way, a third inspection strip IS3 is recorded and also supplements the inspection result IR, which is thus being further enlarged and built up, which is then shown below in FIG. 8.

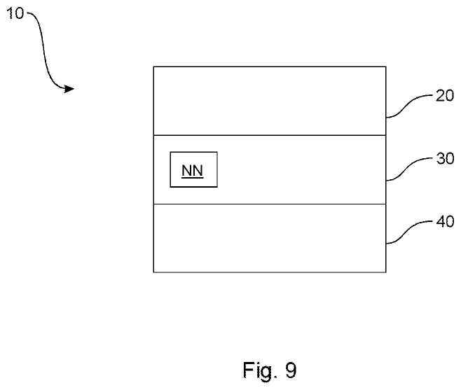

FIG. 9 shows schematically the structure of an evaluation device 10 according to the disclosure. This is equipped with a scanning module 20, an evaluation module 30 and an output module 40 for carrying out the method steps described. Here, a neural network NN, in particular in the form of a neural chip, is provided in the evaluation module 30 to provide the desired evaluation as well to prepare the output of the inspection result.

The above explanation describes the present disclosure exclusively in the context of examples. Naturally, individual features of the embodiments can, where technically expedient, be combined freely with each other without departing from the scope of the present disclosure.

1. A method for detecting alarm objects (AO) in items of luggage (L) in a detection device, comprising:
scanning a first two-dimensional inspection strip (IS1) of a first part of the item of luggage (L),
evaluating the first two-dimensional inspection strip (IS1) for the presence of partial sections (PS) of alarm objects (AO),
outputting an inspection result (IR) based on the evaluation of the first inspection strip (IS1),
scanning at least a second two-dimensional inspection strip (IS2, IS3) of a second part of the item of luggage (L),
evaluating the second two-dimensional inspection strip (IS2) for the presence of partial sections (PS) of alarm objects (AO), and
outputting an inspection result (IR) based on the evaluation of the second inspection strip (IS2).

2. The method according to claim 1, wherein, in addition to the presence of partial sections (PS) of alarm objects (AO), their relative position in relation to lateral margins (LM) of the inspection strip (IS1, IS2, IS3) is recorded during the evaluation.

3. The method according to claim 2, wherein, where a recorded relative position of the partial section (PS) is in direct contact with a lateral margin (LM), a combination with the inspection strip (IS1, IS2, IS3) adjacent to this lateral margin (LM) takes place when the inspection result (IR) is output.

4. The method according to claim 1, wherein optical marking (OM) of the present partial section (PS) of the alarm object (AO) and/or the present complete alarm object (AO) is carried out for the output of the inspection result (IR).

5. The method according to claim 4, wherein in the case of an alarm object (AO) which extends over at least two inspection sections (IS1, IS2), the optical marking (OM) is generated as the smallest possible boundary, in particular with a specified geometric shape.

6. The method according to claim 1, wherein the inspection strips (IS1, IS2) overlap with each other, in particular along a scanning direction (SD).

7. The method according to claim 1, wherein the scanned inspection strips (IS1, IS2) have identical or substantially identical inspection widths (IW).

8. The method according to claim 1, wherein an inspection width (IW) is variable for at least one inspection strip (IS1, IS2) which is to be scanned.

9. The method according to claim 1, wherein the output of the inspection result (IR) takes place continuously after each evaluation of an individual inspection strip (IS1, IS2).

10. The method according to claim 1, wherein the evaluation of the inspection strips (IS1, IS2) is carried out by means of a neural network (NN), in particular for all inspection strips (IS1, IS2) with an identical neural network (NN).

11. The method according to claim 1, wherein the inspection strips (IS1) are directly or substantially directly adjacent to each other.

12. An evaluation device for detecting alarm objects (AO) in items of luggage (L) in a detection device, comprising a scanning module for scanning a first two-dimensional inspection strip (IS1) of a first part of the item of luggage (L) and for scanning at least one second two-dimensional inspection strip (IS2) of a second part of the item of luggage (L), further comprising an evaluation module for evaluating the first two-dimensional inspection strip (IS1) for the presence of partial sections (PS) of alarm objects (AO) and for evaluating the second two-dimensional inspection strip (IS2) for the presence of partial sections (PS) of alarm objects (AO) as well as an output module for outputting an inspection result (IR) based on the evaluations of the inspection strips (IS1, IS2).

13. (canceled)

14. A computer program product comprising commands which, when the program is run by a computer, cause it to carry out the steps of a method having the features of claim 1.
